(19) United States
(12) Patent Application Publication
(10) Pub. No.: US 2022/0276679 A1
(43) Pub. Date: Sep. 1, 2022

(54) ANTI-FINGERPRINT ENCLOSURES

(71) Applicant: Hewlett-Packard Development Company, L.P., Spring, TX (US)

(72) Inventors: Kuan-Ting Wu, Taipei City (TW); Ya-Ting Yeh, Taipei City (TW); Hsing-Hung Hsieh, Taipei City (TW)

(73) Assignee: Hewlett-Packard Development Company, L.P., Spring, TX (US)

(21) Appl. No.: 17/637,476

(22) PCT Filed: Nov. 14, 2019
(86) PCT No.: PCT/US2019/061415

§ 371 Date: Feb. 23, 2022

(51) Int. Cl. G06F 1/16; C23C 18/12; C23C 28/00; C25D 11/24

(52) U.S. Cl. CPC G06F 1/1656; C23C 18/1254; C23C 18/1241; C23C 18/1204; C23C 28/321; C23C 28/34; C25D 11/246

(57) ABSTRACT

Examples of an anti-fingerprint enclosure for an electronic device have been described. In an example, the enclosure comprises an aluminum alloy substrate; a sealing layer deposited on a surface of the aluminum alloy substrate; and a magnesium fluoride sol-gel derived film deposited on the sealing layer, wherein the magnesium fluoride sol-gel derived film exhibits a refractive index of from about 1.36 to about 1.44.

### BACKGROUND

Consumer electronic devices such as mobile phones, laptops, and the like have now become common place. In addition to enjoying the functions and features of an electronic devices, consumers also expect the electronic devices to have an aesthetically attractive appearance. For example, in case of hand-held electronic devices that are housed within enclosures, the enclosures are provided with anti-corrosion and anti-fingerprint surfaces for enhanced user experience.

### BRIEF DESCRIPTION OF DRAWINGS

The following detailed description references the drawings, wherein:

FIG. 1 illustrates a sectional view of an anti-fingerprint enclosure, according to an example of the present disclosure;

FIG. 2 illustrates a sectional view of an anti-fingerprint enclosure comprising an anodized layer, according to an example of the present disclosure;

FIG. 3 illustrates a method of forming an anti-fingerprint enclosure, according to another example of the present disclosure;

FIG. 4 illustrates a method of forming an anti-fingerprint film for an enclosure, according to an example of the present disclosure;

### DETAILED DESCRIPTION

### Definitions

For convenience, before further description of the present disclosure, certain terms employed in the specification, and examples are described here. These definitions should be read in the light of the remainder of the present disclosure. The terms used herein have the meanings recognized and known to those of skill in the art, however, for convenience and completeness, particular terms and their meanings are set forth below.

The articles “a”, “an”, and “the” are used to refer to one or to more than one (i.e., to at least one) of the grammatical object of the article.

The term “about” when referring to a numerical value is intended to encompass the values resulting from variations that can occur during the normal course of performing a method. Such variations are usually within plus or minus 5 to 10 percent of the stated numerical value.

The term “weight percentage”, or “wt %”, of a component used herein refers to a percentage weight of that component relative to 100% weight of the sot gel coating.

The term “aluminum alloy substrate” refers to a frame containing aluminum alloy that is used to obtain the device cover or enclosure of the present disclosure. The aluminum alloy substrate in the present disclosure is selected from AL5005, A380, AL5050, AL5052, AL5154, AL5252, AL6061, AL6063, AL6151, AL6162, AL6205, AL7072, AL7075, AL7475, AL1100, AL575, A413, ADC12, or combinations thereof.

The term “anti-fingerprint” used herein refers to a reduction in the visibility of fingerprints on a surface (i.e., finger smudges). Such reduction may be achieved by a film formed from sot-gel derived MgF₂ coating of the present disclosure. The coating imparts hydrophobicity, i.e., contact angle of water>100° to a surface, and resistance to adherence of a particulate or liquid matter found in fingerprint to a surface, or a combination thereof. The sol-gel derived MgF₂ film has MgF₂ with a particle size of from about 20 nm to about 200 nm.

The phrase “sol-gel derived film” used herein refers to a technique for the preparation of thin film. Various parameters involved in the technique, for example, concentration and composition of the corresponding, synthesis temperature, solvents, sequence of the added precursors, can be modulated desirably to get the type of material required and hence, thin films having desirable properties and applications can be formed.

The term “average transmittance” used herein refers to optical transmittance. It may be defined as the percentage of incident optical power within a given wavelength range transmitted through a material (e.g. the enclosure or portions thereof). The higher the average value transmittance, the higher is the transparency of the surface of the enclosure.

Enclosures, or body of electronic devices, are made of metal enclosures that have strength, resistance towards corrosion. Embodiments of this disclosure pertain to suitable materials for such enclosures, which exhibit weight and/or resistance to impact damage (e.g., denting) and include an anti-fingerprint surface. The embodiments herein pertain to enclosures including a substrate having an anti-fingerprint surface. As used herein the terms “enclosure” maybe used interchangeably with “housing” and “cover or protective cover”. Such enclosures may form a back surface of an electronic device and/or any of the edges of the electronic device.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

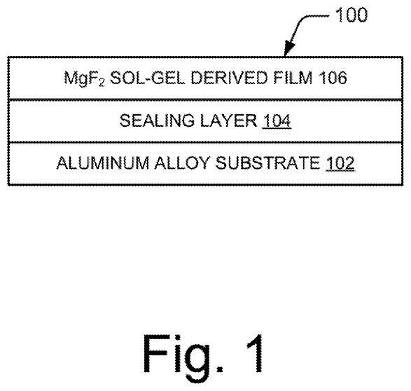

FIG. 1 illustrates ,a sectional view of an anti-fingerprint enclosure 100, according to an example of the present disclosure. The anti-fingerprint enclosure 100, includes an aluminum alloy substrate 102, a sealing layer 104, and a MgF₂ sol-gel derived film 106.

In an example, the aluminum alloy substrate 102, may be selected from AL5005, A380, AL5050, AL5052, AL5154, AL5252, AL6061, AL6063, AL6151, AL6162, AL6205, AL7072, AL7075, AL7475, AL1100, AL575, A413, ADC12, or combinations thereof. In an example, the alloy substrate 102, may be AL5005. In another example, the alloy substrate 102, may be made up of A380. In another example, aluminum alloy substrate may be replaced by aluminum substrate. In case if the substrate is aluminum substrate, it may be formed of aluminum metal.

In an example, the aluminum alloy substrate 102, may be of a thickness in a range of from about 0.3 to 2.0 mm. In another example, the aluminum alloy substrate 102, may be of a thickness in a range of from about 0.5 to 1.8 mm. In another example, the aluminumalloy substrate 102 may be of a thickness of 0.7 mm.

In an example, the aluminum alloy substrate 102 may be anodized before depositing the sealing layer 104. In another example, the aluminum alloy substrate 102, may be passivated prior to anodization, by degreasing, alkaline etching, chemical polishing, acidic washing, neutralization, or combinations thereof. In an example, the aluminum alloy substrate 102, may be cleaned, washed, polished, degreased, and/or activated before anodization. For example, the aluminum alloy substrate 102, may be chemically cleaned using an alkaline agent, for example, sodium hydroxide. The aluminum alloy substrate 102, may also be washed in a buffer solution. The cleaning and washing of the metal substrate may help in removing foreign particles, if any, present on the surface of the aluminum alloy substrate.

Further, the aluminum alloy substrate may be chemically polished using abrasives to remove irregularities that may be present on the surface of the aluminum alloy substrate. The aluminum alloy substrate may also be degreased through ultrasonic degreasing to remove impurities, such as fat, grease, or oil from the surface of the aluminum alloy substrate. Further, the aluminum alloy substrate may also be activated through acid treatment for removing the natural oxide layer, if any, present on the surface of the aluminum alloy substrate. In an example degreasing may be done in presence of de-greasing chemicals, such as, sodium caseinate, sodium polyacrylate, sodium polyoxyethylene alkyl ether carboxylate, sodium dodecyl sulfate, or combinations thereof. In another example, the de-greasing chemical may have a concentration of from about 0.3 wt % to about 2.0 wt % based on the total concentration of degreasing chemicals. The degreasing may be carried out in the presence of de-greasing chemicals for a time period of from about 30 seconds to about 180 seconds at a temperature of from about 25° C. to about 60° C. In an example, alkaline etching may be carried out in presence of potassium hydroxide at a temperature of from about 40° C. to about 60° C. for a time period of from about 30 seconds to about 180 seconds. In an example, chemical polishing may be carried out in presence of chemicals, such as, acetic acid, nitric acid, or phosphoric acid. In another example, the polishing chemicals may have an amount of from about 2 wt % to about 5 wt % based on the total weight of the chemicals. In another example, chemical polishing may be carried out for a time-period of from about 15 seconds to about 60 seconds. In an example, the neutralization may be carried out in presence of chemicals, such as, ammonium oxalate, sodium bicarbonate, sodium carbonate, or combinations thereof. In another example, neutralizing chemicals may have an amount of from about 3 wt % to about 6 wt % based on the total weight of neutralizing chemicals. In another example, neutralization may be carried out for a time-period of from about 30 seconds to about 120 seconds.

In an example, a sealing layer 104, may be deposited on a surface of the aluminum alloy substrate 102. In another example, a sealing layer 104, may be deposited on a surface of the passivated aluminum alloy substrate, In yet another example, a sealing layer 104, may be deposited on a surface of the anodized aluminum alloy substrate. The aluminum alloy substrate 102, may be passivated by any of the process selected from degreasing, alkaline etching, chemical polishing, acidic washing, neutralization, or combinations thereof to obtain a passivated aluminum alloy substrate. In an example, the passivated aluminum alloy substrate may be anodized to obtain an anodized aluminum alloy substrate. The anodization may be carried out at voltage of from about 10 V to about 60 V at a temperature of from about 15° C. to about 30° C. for a period of from about 20 minutes to about 50 minutes, In another example, the anodization may be carried out at voltage of from about 20 V to about 40 V at a temperature of from about 20° C. to about 30° C. for a period of from about 25 minutes to about 40 minutes. In yet another example, the anodization may be carried out at voltage of from about 20 V to about 30 V at a temperature of from about 20° C. to about 25° C. for a period of from about 25 minutes to about 30 minutes,

In an example, the anodized aluminum alloy substrate may be sealed by a sealing layer 104. The sealing layer may reduce the porosity and adsorption capacity of the oxide layer and improve corrosion resistance of the anodized aluminum alloy substrate. In an example, the sealing may be carried out by a process selected from nickel sealing or non-nickel sealing. The nickel sealing may be carried out in presence of nickel fluoride, nickel acetate, or combinations thereof. In another example, the sealing may be carried out in presence of non-nickel sealing process. The non-nickel sealing process may be carried out in presence of aluminum fluoride, cerium fluoride, cerium acetate, chromium (III) hydroxide, aluminum acetate, or combinations thereof. In an example, the sealing may be carried out in the presence of nickel fluoride. In another example, the sealing may be carried out in the presence of nickel acetate. In yet another example, the sealing may be carried out in the presence of aluminum fluoride, In an example baking may be carried out before sealing or it may be used as an alternative to sealing. In an example, the baking may be carried out at a temperature in the range of from about 60° C. to about 90° C. for a period in the range of about 15 seconds to about 180 seconds. In an example, the sealing layer may be baked at a temperature in the range of from about 62 to about 88 for a period in the range of about 30 seconds to about 60 seconds. In another example, the baking may be carried out at a temperature of 70° C. for a period of 45 seconds. In an example, the sealing layer thus obtained may have a thickness of about 0.3 μm to about 5.0 μm. In another example, the sealing layer may have a thickness of about 1.0 μm to about 3.0 μm. In yet another example, the sealing layer may have a thickness of about 2.0 μm to about 2.8 μm.

In an example, the anti-fingerprint enclosure 100, comprises a magnesium fluoride sol-gel derived film 106, which may be deposited on the sealing layer 104. The magnesium fluoride sol-gel derived film exhibits a refractive index of from about 1.36 to about 1.44. In an example, the magnesium fluoride sol.-gel derived film 106, exhibits a refractive index of from about 1.38 to about 1.40. In an example, the magnesium fluoride sol-gell derived film 106, may be deposited on the sealing layer 104, wherein depositing is carried out at a temperature of from about 25° C. to about 35° C. In an example, the magnesium fluoride sol-gel derived film may have a thickness of from about 0.5 μm to about 15.0 μm. In another example, the magnesium fluoride sol-gel derived film may have a thickness of from about 1.0 μm to about 10.0 μm. In yet another example, the magnesium fluoride sol-gel derived film may have a thickness of from about 5.0 μm to about 8.0 μm. In an example, the magnesium fluoride sol-gel derived film may have a thickness of 6.0 μm. The magnesium fluoride sol-gel film 106, may be formed from a sol-gel coating solution comprising magnesium fluoride in an amount of from about 1 wt % to about 3 wt % based on the total weight of the sal-gel coating solution; tetraethoxy silane in an amount of from about 10 wt % to about 30 wt % based on the total weight of the sol-gel coating solution; and at least one long chain polymer in an amount of from about 0.1 wt % to about 1.5 wt % based on the total weight of the sol-gel coating solution.

In an example, the anti-fingerprint enclosure 100, may have an average transmittance of from about 93% to about 98% at a wavelength of from about 400 to about 1000 nm, and a water contact angle of from about 100° to about 115°. In another example, the anti-fingerprint enclosure 100, may have an average transmittance of from about 94% to about 98% at a wavelength of from about 400 to about 1000 nm, and a water contact angle of from about 100° to about 115°. In yet another example, the anti-fingerprint enclosure 100, may have an average transmittance of from about 96% to about 98% at a wavelength of from about 400 to about 1000 nm, and a water contact angle of from about 100° to about 115°. The designed enclosure with the magnesium fluoride sol-gel derived film may provide a transmittance of from about 93% to about 98% at a wavelength of from about 400 to about 1000 nm. The enclosure may show both anti-finger property with water contact angle of from about 100° to about 115°. Hence, the anti-fingerprint enclosure may exhibit hydrophobicity at the surface of the enclosure, and resistance to the adherence of particulate or liquid matter found in fingerprints to the surface of the enclosure.

As described above, the anti-fingerprint enclosure 100, may exhibit an average transmittance (taking into account both the interior and exterior surface of the enclosure) of from about 93% to about 98%, thereby not affecting the visual appearance of the enclosure.

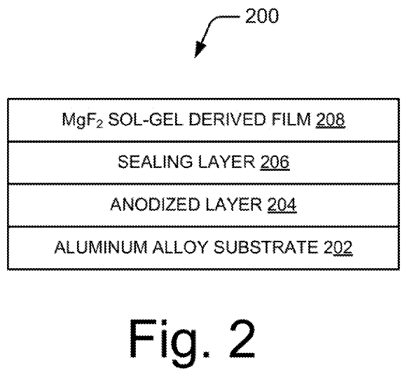

FIG. 2 illustrates a sectional view of an anti-fingerprint enclosure comprising an anodized layer 200, according to an example of the present disclosure. As shown in. FIG. 2, the anti-fingerprint enclosure 200 includes an aluminum alloy substrate 202, an anodized layer 204, a sealing layer 206, and a MgF₂ sol-gel derived film 208.

In an example, the aluminum alloy substrate 202, may be selected from AL5005, A380, AL5050, AL5052, AL5154, AL5252, AL6061, AL6063, AL6151, AL6162, AL6205, AL7072, AL7075, AL7475, AL1100, AL575, A413, ADC12, or combinations thereof. In an example, the aluminum alloy substrate 102, may be AL5005. In another example, the alloy substrate 202, may be made up of A380. In another example, aluminum alloy substrate may be replaced by aluminum substrate. In case if the substrate is aluminum substrate, it may be formed from aluminum metal.

In an example, the aluminum alloy substrate 102 of FIG. 1, and aluminum alloy substrate 202 of FIG. 2, may be same or different. In an example, the aluminum alloy substrate 202 may be same as the aluminum alloy substrate 102. In an example, the aluminum alloy substrate 202, may be of a thickness in a range of from about 0.3 to 2.0 mm. In another example, the aluminum alloy substrate 202, may be of a thickness in a range of from about 0.5 to 1.8 mm. In another example, the aluminum alloy substrate 202, may be of a thickness of 0.7 mm.

In an example, the aluminum alloy substrate 202 may be anodized to obtain an anodized layer 204, between the aluminum alloy substrate 202, and sealing layer 206. In an example, the anodized layer may have a thickness of from about 5 μm to about 12 μm. In another example, the anodized layer 204, may have a thickness of from about 5 μm to about 10 μm. In yet another example, the anodized layer 204, may have a thickness of from about 8 μm to about 10 μm. The anodization may be carried out at voltage of from about 10 V to about 60 V at a temperature of from about 15° C. to about 30° C. for a period of from about 20 minutes to about 50 minutes to obtain the anodized layer 204. In another example, the anodization may be carried out at voltage of from about 20 V to about 40 V at a temperature of from about 20° C. to about 30° C. for a period of from about 25 minutes to about 40 minutes to obtain the anodized layer 204. In yet another example, the anodization may be carried out at voltage of from about 20 V to about 30 V at a temperature of from about 20° C. to about 25° C. for a period of from about 25 minutes to about 30 minutes to obtain the anodized layer 204. In another example, the aluminum alloy substrate 202, may be passivated prior to anodization, by degreasing, alkaline etching, chemical polishing, acidic washing, neutralization, or combinations thereof. In an example, the aluminum alloy substrate 202, may be cleaned, washed, polished, degreased, and/or activated before anodization. The aluminum alloy substrate 202, may be chemically cleaned using an alkaline agent, for example, sodium hydroxide. The aluminum alloy substrate 202, may be washed in a buffer solution, The cleaning and washing of the metal substrate may help in removing foreign particles, if any, present on the surface of the aluminum alloy substrate. Further, the aluminum alloy substrate may be chemically polished using abrasives to remove irregularities that may be present on the surface of the aluminum alloy substrate. The aluminum alloy substrate may also be degreased through ultrasonic degreasing to remove impurities, such as fat, grease, or oil from the surface of the aluminum alloy substrate. Further, the aluminum alloy substrate may also be activated through acid treatment for removing the natural oxide layer, if any, present on the surface of the aluminum alloy substrate. In an example degreasing may be done in presence of de-greasing chemicals, such as, sodium caseinate, sodium polyacrylate, sodium polyoxyethylene alkyl ether carboxylate, sodium dodecyl sulfate, or combinations thereof. In another example, the de-greasing chemical may have a concentration of from about 0.3 wt % to about 2.0 wt % based on the total concentration of degreasing chemicals. The degreasing may be carried out in the presence of de-greasing chemicals for a time period of from about 30 seconds to about 180 seconds at a temperature of from about 25° C. to about 60° C. In an example, alkaline etching may be carried out in presence of potassium hydroxide at a temperature of from about 40 to about 60° C. for a time period of from about 30 seconds to about 180 seconds. In an example, chemical polishing may be carried out in presence of chemicals, such as, acetic acid, nitric acid, or phosphoric acid. In another example, the polishing chemicals may have an amount of from about 2 wt % to about 5 wt % based on the total weight of the chemicals. In another example, chemical polishing may be carried out for a time-period of from about 15 seconds to about 60 seconds. In an example, the neutralization may be carried out in presence of chemicals, such as, ammonium oxalate, sodium bicarbonate, sodium carbonate, or combinations thereof. In another example, neutralizing chemicals may have an amount of from about 3 wt % to about 6 wt % based on the total weight of neutralizing chemicals. In another example, neutralization may be carried out for a time-period of from about 30 seconds to about 120 seconds.

In an example, a sealing layer 206, may be deposited on a surface of the anodized layer 204. In another example, a sealing layer 204, may be deposited on a surface of the passivated aluminum alloy substrate. The aluminum alloy substrate 202, may be passivated by any of the process selected from degreasing, alkaline etching, chemical polishing, acidic washing, neutralization, or combinations thereof to obtain a passivated aluminum alloy substrate. In an example, the passivated aluminum alloy substrate may be anodized to obtain an anodized layer 204.

In an example, the anodized layer 204, may be sealed by a sealing layer 206. The sealing layer may reduce the porosity and adsorption capacity of the oxide layer and improve corrosion resistance of the anodized aluminum alloy substrate. In an example, the sealing may be carried out by a process selected from nickel sealing or non-nickel sealing. The nickel sealing may be carried out in presence of nickel fluoride, nickel acetate, or combinations thereof. In another example, the sealing may be carried out in presence of non-nickel sealing process. The non-nickel sealing process may be carried out in presence of aluminum fluoride, cerium fluoride, cerium acetate, chromium (III) hydroxide, aluminum acetate, or combinations thereof. In an example, the sealing may be carried out in the presence of nickel fluoride. In another example, the sealing may be carried out in the presence of nickel acetate. In yet another example, the sealing may be carried out in the presence of aluminum fluoride. In an example, the baking may be carried out at a temperature in the range of from about 60° C. to about 90° C. for a period in the range of about 15 seconds to about 180 seconds. In an example, the sealing layer may be baked at a temperature in the range of from about 62° C. to about 88° C. for a period in the range of about 30 seconds to about 60 seconds. In another example, the baking may be carried out at a temperature of 70° C. for a period of 45 seconds. In an example, the sealing layer thus obtained may have a thickness of about 0.3 μm to about 5.0 μm. In another example, the sealing layer may have a thickness of about 1.0 μm to about 3.0 μm. In yet another example, the sealing layer may have a thickness of about 2.0 μm to about 2.8 μm.

In an example, anti-fingerprint enclosure 200, comprises a magnesium fluoride sal-gel derived film 208, which may be deposited on the sealing layer 206. The magnesium fluoride sol-gel derived film 208, exhibits a refractive index of from about 1.36 to about 1.44. In an example, the magnesium fluoride sol-gel derived film 208, exhibits a refractive index of from about 1.38 to about 1.40. In an example, the magnesium fluoride sol-gel derived film 208, may be deposited on the sealing layer 206, wherein depositing is carried out at a temperature of from about 25° C. to about 35° C. In an example, the magnesium fluoride sal-gel derived film 208, may have a thickness of from about 0.5 μm to about 15.0 μm. In another example, the magnesium fluoride sal-gel derived film 208, may have a thickness of from about 1.0 μm to about 10.0 μm. In yet another example, the magnesium fluoride sal-gel derived film 208, may have a thickness of from about 5.0 μm to about 8.0 μm. In an example, the magnesium fluoride sal-gel derived film 208, may have a thickness of 6.0 μm.

In an example, the anti-fingerprint enclosure 200, may have an average transmittance of from about 93% to about 98% at a wavelength of from about 400 to about 1000 nm, and a water contact angle of from about 100° to about 115°. in another example, the anti-fingerprint enclosure 200, may have an average transmittance of from about 94% to about 98% at a wavelength of from about 400 to about 1000 nm, and a water contact angle of from about 100° to about 115°. In yet another example, the anti-fingerprint enclosure 200, may have an average transmittance of from about 96% to about 98% at a wavelength of from about 400 to about 1000 nm, and a water contact angle of from about 100° to about 115°. The designed enclosure 200, with the magnesium fluoride sal-gel derived film may provide a transmittance of from about 93% to about 98% at a wavelength of from about 400 to about 1000 nm. The enclosure 200, may show both anti-fingerprint property with water contact angle of from about 100° to about 115°. These data indicate hydrophobicity to the surface of the enclosure, and resistance to the adherence of particulate or liquid matter found in fingerprints to the surface of the enclosure 200. The anti-fingerprint enclosure 200, may exhibit an average transmittance (taking into account both the interior and exterior surface of the enclosure) of from about 93% to about 98%.

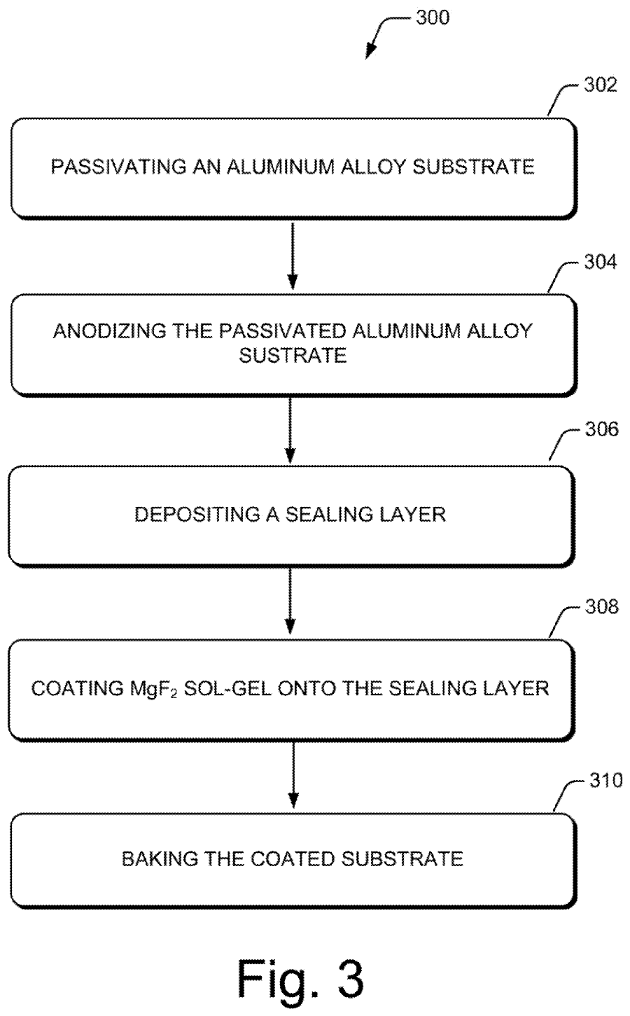

FIG. 3 illustrates a method of forming an anti-fingerprint enclosure 300, according to another example of the present disclosure. As shown in FIG. 3, wherein the flow chart shows a method for forming an anti-fingerprint enclosure comprises passivating an aluminum substrate, 302, to obtain a passivated aluminum substrate. The passivated aluminum substrate is anodized, 304, to obtain an anodized aluminum substrate. Further, a sealing layer is deposited, 306, on the anodized aluminum substrate followed by coating a magnesium fluoride sol-gel onto the sealing layer, 308, to obtain a coated substrate; and finally baking the coated substrate, 310, at a temperature of from about 80° C. to about 200° C.; for a time period of from about 20 to about 60 minutes to form the anti-fingerprint enclosure, 300.

In an example, the method for forming an anti-fingerprint enclosure comprises passivating the aluminum alloy substrate, 302, wherein passivation may be carried out by any of the processes selected from degreasing, alkaline etching, polishing, neutralizing, or combinations thereof to obtain a passivated aluminum alloy substrate. In an example degreasing may be done in presence of de-greasing chemicals, such as, sodium caseinate, sodium polyacrylate, sodium polyoxyethylene alkyl ether carboxylate, sodium dodecyl sulfate, or combinations thereof to obtain a passivated aluminum alloy substrate, In an example, the de-greasing chemical may have a concentration of from about 0.3 wt % to about 2.0 wt % based on the total concentration of degreasing chemicals. In an example, the de-greasing chemical may have a concentration of from about 0.5 wt % to about 1.5 wt % based on the total concentration of degreasing chemicals. In another example, the de-greasing chemical may have a concentration of from about 0.8 wt % to about 1.2 wt % based on the total concentration of degreasing chemicals. In an example, degreasing may be carried out in the presence of de-greasing chemicals for a time period of from about 30 seconds to about 180 seconds at a temperature of from about 25° C. to about 60° C. to obtain a passivated aluminum alloy substrate. In another example, degreasing may be carried out in the presence of de-greasing chemicals for a time period of from about 60 seconds to about 150 seconds at a temperature of from about 25° C. to about 60° C. to obtain a passivated aluminum alloy substrate. In yet another example, degreasing may be carried out in the presence of de-greasing chemicals for a time period of from about 60 seconds to about 120 seconds at a temperature of from about 25° C. to about 50° C. to obtain a passivated aluminum alloy substrate. In an example, the aluminum alloy substrate may be chemically cleaned using an alkaline agent, for example, sodium hydroxide to obtain a passivated aluminum alloy substrate, In an example, the aluminum alloy substrate may be washed in a buffer solution to obtain a passivated aluminum alloy substrate. The cleaning and washing of the metal substrate may help in removing foreign particles, if any, present on the surface of the aluminum alloy substrate. Further, the aluminum alloy substrate may also be cleaned by acid treatment for removing the natural oxide layer, if any, present on the surface of the aluminum alloy substrate to obtain a passivated aluminum alloy substrate. In an example, the aluminum alloy substrate may be alkaline etched in presence of potassium hydroxide at a temperature of from about 40 to about 60° C. for a time period of from about 30 seconds to about 180 seconds to obtain a passivated aluminum alloy substrate. In another example, the aluminum alloy substrate may be alkaline etched in presence of potassium hydroxide at a temperature of from about 50° C. to about 65° C. for a time period of from about 30 seconds to about 160 seconds to obtain a passivated aluminum alloy substrate. In yet another example, the aluminum alloy substrate may be alkaline etched in presence of potassium hydroxide at a temperature of from about 50° C. to about 60° C. for a time period of from about 30 seconds to about 120 seconds to obtain a passivated aluminum alloy substrate, In an example, aluminum alloy substrate, or degreased aluminum alloy substrate, or cleaned and washes aluminum alloy substrate may be chemically polished in presence of chemicals, such as, acetic acid, nitric acid, or phosphoric acid to obtain a passivated aluminum alloy substrate. In an example, the polishing chemicals may have an amount of from about 2 wt % to about 5 wt % based on the total weight of the chemicals. In another example, the polishing chemicals may have an amount of from about 2.5 wt % to about 4.5 wt % based on the total weight of the chemicals. In yet another example, the polishing chemicals may have an amount of from about 3 wt % to about 4 wt % based on the total weight of the chemicals. In an example, chemical polishing may be carried out for a time-period of from about 15 seconds to about 60 seconds to obtain a passivated aluminum alloy substrate. In another example, chemical polishing may be carried out for a time-period of from about 20 seconds to about 50 seconds to obtain a passivated aluminum alloy substrate. In yet another example, chemical polishing may be carried out for a time-period of from about 20 seconds to about 40 seconds to obtain a passivated aluminum alloy substrate. In an example, the neutralization may be carried out in presence of chemicals, such as, ammonium oxalate, sodium bicarbonate, or combinations thereof to obtain a passivated aluminum alloy substrate. In an example, neutralizing chemicals may have an amount of from about 3 wt % to about 6 wt % based on the total weight of neutralizing chemicals. In another example, neutralizing chemicals may have an amount of from about 3.5 wt % to about 6 wt % based on the total weight of neutralizing chemicals. In yet another example, neutralizing chemicals may have an amount of from about 3.0 wt % to about 5.5 wt % based on the total weight of neutralizing chemicals. In an example, neutralization may be carried out for a time-period of from about 30 seconds to about 120 seconds to obtain a passivated aluminum alloy substrate. In another example, neutralization may be carried out for a time-period of from about 30 seconds to about 100 seconds to obtain a passivated aluminum alloy substrate. In yet another example, neutralization may be carried out for a time-period of from about 30 seconds to about 60 seconds to obtain a passivated aluminum alloy substrate,

In an example, the passivated aluminum alloy substrate may be anodized, 304, to obtain an anodized aluminum substrate. In an example, anodizing the passivated aluminum alloy substrate may be carried out at voltage of from about 10 V to about 60 V at a temperature of from about 15° C. to about 30° C. for a period of from about 20 minutes to about 50 minutes to obtain the anodized aluminum substrate. In another example, the anodization may be carried out at voltage of from about 20 V to about 40 V at a temperature of from about 20° C. to about 30° C. for a period of from about 25 minutes to about 40 minutes to obtain the anodized aluminum substrate. In yet another example, the anodization may be carried out at voltage of from about 20 V to about 30 V at a temperature of from about 20° C., to about 25° C. for a period of from about 25 minutes to about 30 minutes to obtain the anodized aluminum substrate. In an example, the method of forming an anti-fingerprint enclosure comprises depositing a sealing layer on the anodized aluminum alloy substrate. In an example, depositing the sealing layer on the anodized aluminum substrate is carried out at a temperature of from about 25° C. to about 95° C. for a time period of from about 30 to about 180 seconds. In another example, depositing the sealing layer on the anodized aluminum substrate is carried out at a temperature of from about 25° C. to about 85° C. for a time period of from about 30 to about 160 seconds. In yet another example, depositing the sealing layer on the anodized aluminum substrate is carried out at a temperature of from about 25° C. to about 65° C. for a time period of from about 30 to about 120 seconds. The sealing layer may reduce the porosity and adsorption capacity of the oxide layer and improve corrosion resistance of the anodized aluminum alloy substrate, In an example, the sealing may be carried out by a process selected from nickel sealing or non-nickel sealing. The nickel sealing may be carried out in presence of nickel fluoride, nickel acetate, or combinations thereof. In another example, the nickel sealing components may have a concentration of about 0.3% to about 1.0%. In another example, the sealing may be carried out in presence of non-nickel sealing process. The non-nickel sealing process may be carried out in presence of aluminum fluoride, cerium fluoride, cerium acetate, chromium (III) hydroxide, aluminum acetate, or combinations thereof. In an example, the sealing may be carried out in the presence of nickel fluoride. In another example, the sealing may be carried out in the presence of nickel acetate. In yet another example, the sealing may be carried out in the presence of aluminum fluoride. In an example, sealing layer, may be dried at a temperature in the range of from about 60° C. to about 90° C. for a period in the range of about 15 seconds to about 180 seconds. In another example, the sealing layer may be dried at a temperature in the range of from about 62° C. to about 88° C. for a period in the range of about 30 seconds to about 60 seconds. In yet another example, the drying may be carried out at a temperature of 70° C. for a period of 45 seconds. In an example, the sealing layer thus obtained may have a thickness of about 0.3 μm to about 5.0 μm, in another example, the sealing layer may have a thickness of about 1.0 μm to about 3.0 μm. In yet another example, the sealing layer may have a thickness of about 2.0 μm to about 2.8 μm. In an example, method for forming an anti-fingerprint enclosure 300, comprises coating a magnesium fluoride sal-gel on to the sealing layer, 308, to obtain a coated substrate. The magnesium fluoride sol-gel comprises magnesium fluoride in an amount of from about 1 wt % to about 3 wt % based on the total weight of the sol-gel; tetraethoxy silane in an amount of from about 10 wt % to about 30 wt % based on the total weight of the sal-gel; and at least long chain polymer in an amount of from about 0.1 wt % to about 1.5 wt % based on the total weight of the sol-gel. in an example, coating the magnesium fluoride sol-gel onto the sealing layer may be carried out at a temperature of from about 25° C. to about 35° C. to obtain the coated substrate. In another example, coating the magnesium fluoride sol-gel onto the sealing layer may be carried out at a temperature of from about 28° C. to about 34° C. to obtain the coated substrate. As illustrated in FIG. 3, baking the coated substrate, 310, may be carried out ata temperature of from about 80° C. to about 200° C. for a time period of from about 20 to about 60 minutes to form the anti-fingerprint enclosure. In another example, baking the coated substrate, 310, may be carried out at a temperature of from about 80° C. to about 180° C. for a time period of from about 30 to about 60 minutes to form the anti-fingerprint enclosure. In an example, the magnesium fluoride sol-gel coating after baking, may have a thickness of from about 0.5 μm to about 15.0 μm. In another example, the magnesium fluoride sal-gel coating after baking, may have a thickness of from about 1.0 μm to about 10.0 μm. In yet another example, the magnesium fluoride sol-gel coating after baking may have a thickness of from about 5.0 μm to about 8.0 μm. In an example, the magnesium fluoride sal-gel coating may have a thickness of 6.0 μm.

In an example, the anti-fingerprint enclosure formed by the method as described in FIG. 3, may have an average transmittance of from about 93% to about 98% at a wavelength of from about 400 to about 1000 nm, and a water contact angle of from about 100° to about 115°. In another example, the anti-fingerprint enclosure, may have an average transmittance of from about94% to about 98% at a wavelength of from about 400 to about 1000 nm, and a water contact angle of from about 100° to about 115°. In yet another example, the anti-fingerprint enclosure 200, may have an average transmittance of from about 96% to about 98% at a wavelength of from about 400 to about 1000 nm, and a water contact angle of from about 100° to about 115°, The designed enclosure formed by the method as described in FIG. 3, may provide a transmittance of from about 93% to about 98% at a wavelength of from about 400 to about 1000 nm. The enclosure, may show both anti-fingerprint property and resistance to the adherence of particulate or liquid matter found in fingerprints to the surface of the enclosure. The water contact angle of from about 100° to about 115 indicate hydrophobicity to the surface of the enclosure. In an example the anti-fingerprint enclosure, may exhibit an average transmittance (taking into account both the interior and exterior surface of the enclosure) of from about 93% to about 98%.

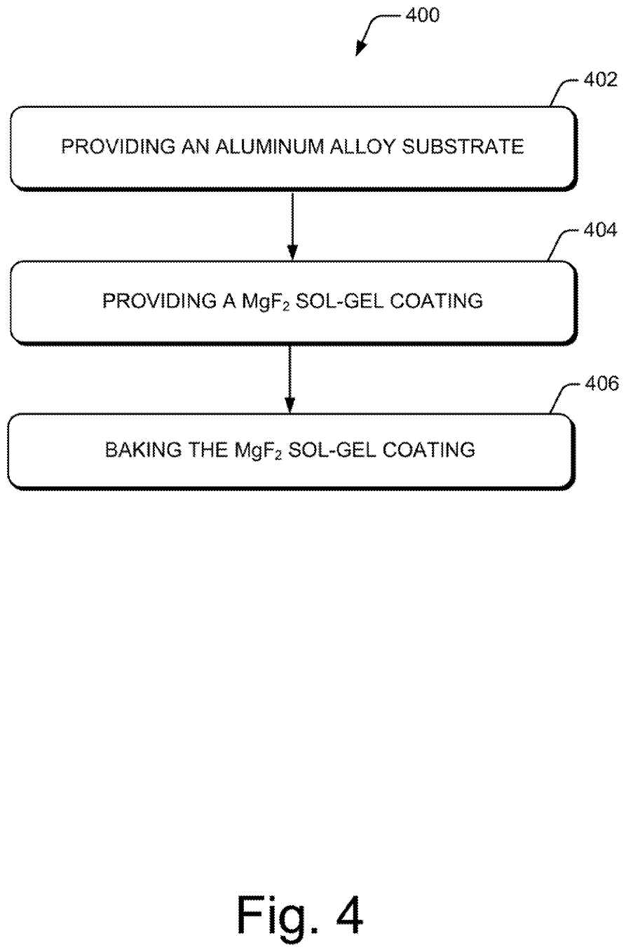

FIG. 4 illustrates a method of forming an anti-fingerprint film for an enclosure, 400, according to an example of the present disclosure. The method 400, involves providing an aluminum alloy substrate, 402, followed by providing a magnesium fluoride sal-gel coating on at least one surface of the aluminum substrate, 404. Finally, baking the magnesium fluoride sol-gel coating, 406, to obtain the anti-fingerprint film. The magnesium fluoride sal gel coating comprises magnesium fluoride in an amount of from about 1 wt % to about 3 wt % based on the total weight of the sal-gel coating; tetraethoxy silane in an amount of from about 10 wt %, to about 30 wt % based on the total weight of the sol-gel coating; and at least one long chain polymer in an amount of from about 0.1 wt % to about 1.5 wt % based on the total weight of the sol-gel coating. In an example, at least long chain polymer may be selected from trimethylchlorosilane, heptadecafluorodecyltrimethoxysilane, heptafluoroisopropoxypropyltrichlorosilane, polytetrafluoroethylene, octadecyldimethylchlorosilane, octadecyltrichlorosilane, tris(trimethylsiloxy)silylethyldimethylchlorosilane, octyldimethylchlorosilane, dimethyldichlorosilane, or butyldimethylchlorosilane. In an example, providing a magnesium fluoride sol-gel coating on at least one surface of the aluminum substrate is carried out by spray coating. In another example, the magnesium fluoride sol-gel coating deposited by spray coating may be followed by heat treatment at a temperature of from about 60° C. to about 80° C. for period in a range of from about 15 to about 40 minutes. In an example, the magnesium fluoride sol-gel coating deposited by spray coating may be followed by UV treatment in a range of from about 700 mJ/cm² to about 1200 mJ/cm² for a period in a range of from about 10 seconds to about 30 seconds. In another example, the magnesium fluoride sol-gel coating deposited by spray coating may be followed by UV treatment in a range of from about 800 mJ/cm² to about 1100 mJ/cm² for a period in a range of from about 15 seconds to about 25 seconds. In another example, the magnesium fluoride sol-gel coating deposited by spray coating may be followed by UV treatment of about 950 mJ/cm² for a period of about 20 seconds.

In an example, the anti-fingerprint film containing magnesium fluoride (MgF₂) has an aspect ratio of from about 8 to about 10. An aspect ratio of from about 8 to about 10 may provide a flat surface, i.e., flatness to a surface to which the anti-fingerprint film of the present disclosure is attached, In an example, the anti-fingerprint film may include features disposed on the surface that are light-scattering (transmittance). In another example, the features may be disposed directly on the surface or indirectly on the surface in a random or non-random manner. In yet another example, randomly disposed features may provide a smooth touch-feeling when the surface is contacted or swiped with a finger or skin. in an example, the anti-fingerprint enclosure of the present disclosure may maintain metallic luster with high abrasion resistance.

Although examples for the present disclosure have been described in a language specific to structural features and/or methods, it is to be understood that the appended claims are not limited to the specific features or methods described herein. Rather, the specific features and methods are disclosed and explained as examples of the present disclosure.

We claim:

1. An anti-fingerprint enclosure for an electronic device, the enclosure comprising:
an aluminum alloy substrate;
a sealing layer deposited on a surface of the aluminum alloy substrate; and
a magnesium fluoride sol-gel derived film deposited on the sealing layer,
wherein the magnesium fluoride sol-gel derived film exhibits a refractive index of from about 1.36 to about 1.44.

2. The anti-fingerprint enclosure as claimed in claim 1, wherein the enclosure comprises an anodized layer having a thickness of from about 5 μm to about 12 μm between the aluminum alloy substrate and the sealing layer.

3. The anti-fingerprint enclosure as claimed in claim 1, wherein the aluminum alloy substrate has a thickness of from about 0.3 mm to about 2 mm.

4. The anti-fingerprint enclosure as claimed in claim 1, wherein the magnesium fluoride sol-gel derived film has a thickness of from about 0.5 μm to about 15.0 μm.

5. The anti-fingerprint enclosure as claimed in claim 1, wherein the sealing layer has a thickness of from about 0.3 μm to about 5.0 μm.

6. The anti-fingerprint enclosure as claimed in claim 1, wherein the enclosure has an average transmittance of from about 93% to about 98% at a wavelength of from about 400 to about 1000 nm, and a water contact angle of from about 100° to about 115°.

7. The anti-fingerprint enclosure as claimed in claim 1, wherein the sealing layer comprises sealant selected from nickel fluoride, nickel acetate, aluminum fluoride, cerium fluoride, cerium acetate, chromium (Ili) hydroxide, aluminum acetate, or combinations thereof.

8. A method for forming an anti-fingerprint enclosure, the method comprising:
passivating an aluminum alloy substrate to obtain a passivated aluminum alloy substrate;
anodizing the passivated aluminum alloy substrate to obtain an anodized aluminum substrate;
depositing a sealing layer on the anodized aluminum alloy substrate;
coating a magnesium fluoride sol-gel onto the sealing layer to obtain a coated substrate; and
baking the coated substrate at a temperature of from about 80° C. to about 200° C. for a time period of from about 20 to about 60 minutes to form the anti-fingerprint enclosure.

9. The method for forming the anti-fingerprint enclosure as claimed in claim 8, wherein passivating the aluminum substrate involves processes selected from degreasing, cleaning, polishing, neutralizing, or combinations thereof.

10. The method for forming an anti-fingerprint enclosure as claimed in claim 8, wherein anodizing the passivated aluminum alloy substrate is carried out at a potential of from about 10 to about 60 V for a period of from about 20 to about 50 minutes at a temperature of from about 15° C. to about 30° C.

11. The method for forming the anti-fingerprint enclosure as claimed in claim 8, wherein depositing the sealing layer on the anodized aluminum substrate is carried out at a temperature of from about 25 to about 95° C.. for a time period of from about 30 to about 180 seconds.

12. The method for forming the anti-fingerprint enclosure as claimed in claim 8, wherein coating a magnesium fluoride sol-gel onto the sealing layer is carried out at a temperature of from about 25° C. to about 35° C. to obtain a coated substrate.

13. A method for forming an anti-fingerprint film for an enclosure comprising:
providing an aluminum alloy substrate;
providing a magnesium fluoride sol-gel coating on at least one surface of the aluminum alloy substrate; and
baking the magnesium fluoride sol-gel coating to obtain the anti-fingerprint film,
wherein the magnesium fluoride sol gel coating comprises magnesium fluoride in an amount of from about 1 wt % to about 3 wt % based on the total weight of the sol-gel coating; tetraethoxy silane in an amount of from about 10 wt % to about 30 wt % based on the total weight of the sol-gel coating and at least one long chain polymer in an amount of from about 0.1 wt % to about 1.5 wt % based on the total weight of the sol-gel coating.

14. The method for forming an anti-fingerprint film for an enclosure as claimed in claim 13, wherein providing a magnesium fluoride sol-gel coating on at least one surface of the aluminum substrate is carried out by spray coating.

15. The method for forming an anti-fingerprint film for an enclosure as claimed in claim 13, wherein the anti-fingerprint film has an aspect ratio of from about 8 to about 10.
